SEQUENCE LISTING (2 sequences)

SEQ ID NO: 1 - DNA, 95 bp, Human adenovirus type 1
gtttttttgtggaacttgacaagctgattctaaaatttatatggaggagaaaagattcaagaatagccaagacattcctgaagaagaagaacaag

SEQ ID NO: 2 - DNA, 341 bp, Human adenovirus type 1
gtaagagccctcccgccactccaaagccttattgccccatccctcaattccctccaccccttccacttctcaggtactagttaatgattggcgtatagacaagaatcatggcatgcctcttgttgcacccacttaacaacatggcgttgccttttgttgcaccttagtggcttctggaaataacgtaaaagccaaaggctttctcctaatgagctaggaacagacatgtccttgcccagctgggattctgtctgcccagggcctgaggtggtgggagcaatgcaaggagagggagaggacaaatgatattggctagccataagccgctattcttcttacag

(19) United States
(12) Patent Application Publication
(10) Pub. No.: US 2012/0193291 A1
(43) Pub. Date: Aug. 2, 2012

(54) MUTANT PTP ALPHA GENE GROUP IN MALIGNANT TUMORS AND PRODUCTION METHOD

(76) Inventor: Zhiwei Pan, Shanghai (CN)

(21) Appl. No.: 13/383,065

(22) PCT Filed: Nov. 25, 2010
(86) PCT No.: PCT/CN2010/079111

§ 371 Date: Jan. 9, 2012

(30) Foreign Application Priority Data
Dec. 29, 2009 (CN) 200910247437.4

(51) Int. Cl. C02F 1/62; C02F 1/64; C02F 1/44; B01D 71/56; C02F 101/22; C02F 101/20

(52) U.S. Cl. 210/651; 210/654

(57) ABSTRACT

A group of mutant PTP α genes in malignant tumor are provided, which are ^{Δ}PTPα245, ^{Δ}PTPα652 and ^{Δ}PTPα445 respectively. The mutation includes insertion of 95 new nucleotides after nucleotide at position 711, deletion of nucleotides at position 1015-1437, and deletion of nucleotides at position 1015-1437 accompanied by insertion of 340 nucleotides after coding exon at position 1681 and fusion of 26 new amino acids at C-terminal. The group of mutant PTP α genes in different types of malignant tumor disclosed in the present application have not been reported all over the world so far. The detection method of using PTP α mutant genes is useful in exactly diagnosing malignant tumor, developing new anti-tumor drugs, and targeted treatment at molecular pathologic level.

### TECHNICAL FIELD

The present invention relates to a mutant PTP α gene group in malignant tumors.

### BACKGROUND ART

Protein Tyrosine Kinases (PTKs) and Protein Tyrosine Phosphatases (PTPs) respectively represent two enzyme families, and both maintain the vital activity of normal cells through positive and negative regulation of phosphorylation and dephosphorylation, e.g. systematic growth, development, differentiation and apoptosis. The appearance of malignant tumor is typically caused by the fact that such normal balance regulation becomes incontrollable, for example, the mutation of one or several key enzymatic genes in the two enzyme families or the activation of enzymatic activity by any factor is essentially responsible for the induction of malignant tumor.

PTP α (Protein Tyrosine Phosphatase a) is a member of the protein tyrosine phosphatase family, consists of 793 amino acids, has the molecular weight of 130 KDa, and can specifically catalyze phosphoric acid modified on tyrosine residue to be dephosphorylated. Signal transduction dominated by Src tyrosine phosphokinase is regulated by dephosphorylating tyrosine phosphokinase-catalyzed substrate of proto-oncogene Src family, in order to maintain normal cell growth and mitosis. PTP α is also receptor-type transmembrane protein tyrosine phosphatase that participates not only in signal channels for Epidermal Growth Factor Receptor (EGFR) and Insulin Receptor (IR), but also in the regulation of cell migration, and that includes the function of inhibiting the apoptosis of tumor cells.

Since PTP α gene was cloned in 1990, relevant mutant PTP α genes in malignant tumors have not been reported domestically and overseas yet and high efficiency technology for detecting the mutant of PTP α gene has not been invented.

### SUMMARY OF THE INVENTION

The technical problem to be solved by the present invention is to provide a mutant PTP a gene in malignant tumors.

The second technical problem to be solved by the present invention is to provide the use of the mutant PTP α gene in diagnosing malignant tumors and in targeted therapy of malignant tumors.

In order to solve the first problem above, the present invention provides three mutant PTP α genes as below: ^{Δ}PTP α 245, ^{Δ}PTP α 652 and ^{Δ}PTP α 445.

A mutant PTP α gene in malignant tumors is characterized in that the gene is ^{Δ}PTP α 245, wild type PTP α gene has the length of 2379 bp with 20 encoding exons in total as follows: exon 1: 1-73 bp; exon 2: 74-415 bp; exon 3: 416-500 bp; exon 4: 501-574 bp; exons: 575-711 bp; exon 6: 712-802 bp; exon 7: 803-879 bp; exon 8: 880-916 bp; exon 9: 917-1014 bp; exon 10: 1015-1134 bp; exon 11: 1035-1301 bp; exon 12: 1302-1437 bp: exon 13: 1438-1587 bp; exon 14: 1588-1681 bp; exon 15: 1682-1758 bp; exon 16: 1759-1893 bp; exon 17: 1894-2019 bp; exon 18: 2020-2171 bp; exon 19: 2172-2307 bp; exon 20: 2308-2379 bp, the mutant location of the mutant PTP α gene: 95 new nucleotide segments are inserted behind the 711^{th} nucleotide; gene modification: partial deletion of the 6^{th} to the 20^{th} encoding exons is initiated; protein modification: protein contains 245 amino acids with 8 new amino acids therein located at c-end.

The 95 new nucleotide sequences are shown as SEQ ID NO: 1.

The 8 new amino acid sequences are shown as follows: -V F L W N L T S-.

A mutant PTP α gene in malignant tumors is characterized in that the gene is ^{Δ}PTP α 652, wild type PTP α gene has the length of 2379 bp with 20 encoding exons in total as follows: exon 1: 1-73 bp; exon 2: 74-415 bp; exon 3: 416-500 bp; exon 4: 501-574 bp; exon 5: 575-711 bp; exon 6: 712-802 bp; exon 7: 803-879 bp; exon 8: 880-916 bp; exon 9: 917-1014 bp; exon 10: 1015-1134 bp; exon 11: 1035-1301 bp; exon 12: 1302-1437 bp: exon 13: 1438-1587 bp: exon 14: 1588-1681 bp; exon 15: 1682-1758 bp; exon 16: 1759-1893 bp; exon 17: 1894-2019 bp; exon 18: 2020-2171 bp; exon 19: 2172-2307 bp; exon 20: 2308-2379 bp, the mutant location of the gene: deletion of the 1015^{th} to 1437^{th} nucleotides; gene modification: deletion of the 10^{th}, 11^{th} and 12^{th} encoding exons is initiated; protein modification: protein contains 652 amino acids;

E in the wild type PTP α gene represents exon;

The ^{Δ}PTP α 652 gene has the deletion of the 10^{th}, 11^{th} and 12^{th} exons and the deletion of 423 nucleotides.

A mutant PTP α gene in malignant tumors is characterized in that the gene is ^{Δ}PTP α 445, wild type PTP α gene has the length of 2379 bp with 20 encoding exons in total as follows: exon 1: 1-73 bp; exon 2: 74-415 bp; exon 3: 416-500 bp; exon 4: 501-574 bp; exon 5: 575-711 bp; exon 6: 712-802 bp; exon 7: 803-879 bp; exon 8: 880-916 bp; exon 9: 917-1014 bp; exon 10: 1015-1134 bp; exon 11: 1035-1301 bp; exon 12: 1302-1437 bp: exon 13: 1438-1587 bp: exon 14: 1588-1681 bp; exon 15: 1682-1758 bp; exon 16: 1759-1893 bp; exon 17: 1894-2019 bp; exon 18: 2020-2171 bp; exon 19: 2172-2307 bp; exon 20: 2308-2379 bp, the mutant location of the gene: deletion of the 1015^{th} to 1437^{th} nucleotides, accompanied with the insertion of 340 nucleotides behind the 1681^{th} encoding exon and the fusion of 26 new amino acids at c-end; gene modification: deletion of the 15^{th} to 20^{th} encoding exons is initiated; protein modification: protein contains 445 amino acids;

The 343 nucleotides are intact 14^{th} intron sequence, which is shown as SEQ ID NO: 2.

The exons of the wild type PTP α gene are shown as FIG. 1, and E represents exon.

The exons of the ^{Δ}PTP α 445 gene are shown as FIG. 4.

In order to solve the second problem above, it is found from the PTP α gene sequencing and analysis on samples of 38 various tumor tissues that a part of PTP α genes is mutant, shown as Table 1 and Table 2.

TABLE 1

| | Gene | Type | Case | Protein |
|---|---|---|---|---|
| Mutant Location | Modification | of Tumor | Number | Modification |
| Insertion of 95 | Deletion of the | Intestinal | 2 | ^{Δ}PTP α 245 |
| nucleotides, | 6^{th} to 20^{th} exons | cancer | | |
| initiation of | | | | |
| deleted sequence | | | | |
| 712 to 2379 | | | | |
| Insertion of 95 | Deletion of the | Mammary | 1 | ^{Δ}PTP α 245 |
| nucleotides, | 6^{th} to 20^{th} exons | cancer | | |
| initiation of | | | | |
| deleted sequence | | | | |
| 712 to 2379 | | | | |
| Insertion of 95 | Deletion of the | Liver | 1 | ^{Δ}PTP α 245 |
| nucleotides, | 6^{th} to 20^{th} exons | cancer | | |
| initiation of | | | | |
| deleted sequence | | | | |
| 712 to 2379 | | | | |
| Deleted | Deletion of the | Mammary | 1 | ^{Δ}PTP α 652 |
| sequence 1015 | 10^{th}, 11^{th} and | cancer | | |
| to 1437 | 12^{th} exons | | | |
| Deleted | Deletion of the | Intestinal | 1 | ^{Δ}PTP α 445 |
| sequence 1015 | 10^{th}, 11^{th} and | cancer | | |
| to 1437, deleted | 12^{th} exons and | | | |
| sequence 1682 | the 15^{th} to 20^{th} | | | |
| to 2379 and | exons | | | |
| insertion of 340 | | | | |
| nucleotides | | | | |

TABLE 2

| | Type of Tumor | | | | | |
|---|---|---|---|---|---|---|
| | Thyroid | Intestinal | Liver | Mammary | Lung | Esophagus |
| | Cancer | Cancer | Cancer | Cancer | Cancer | Cancer |
| Mutant case | 0/10 | 3/8 | 1/2 | 2/9 | 0/7 | 0/2 |
| number/detection | | | | | | |
| case number | | | | | | |
| Mutation percentage | 0% | 38% | 50% | 33% | 0% | 0% |

The RT-PCR results of different types of tumor samples are shown in FIG. 5.

The 26 new amino acid sequences are as follows: -CKTLPPLQSLI APSLNSLHP FHFSGC-.

A production method of a mutant PTP α gene group in malignant tumors is characterized in that the method comprises the following steps of:

A. Cloning of PTP α Mutant Gene

(1) Extraction of Total RNA

A patient's tumor tissue resulting from surgical excision is cut into pieces and RNA is extracted by 1 ml of TRIzol reagent (Invitrogen), the addition of 0.2 ml of chloroform is followed by violent shaking for 15 seconds, placement for 10 minutes at room temperature and centrifugation for 15 minutes at the speed of 15000 rpm at 4° C., supernatant is sucked and added with 0.5 ml of isopropanol for homogeneous mixing, the mixture is put on a standing for 10 minutes and then centrifuged for 10 minutes at the speed of 15000 rpm, the supernatant is removed, precipitates are washed with 75% ethanol and then dissolved in 20 ul of DEPC-H20. After 2 ul of the resultant solution is diluted, absorbance is determined by ultraviolet spectrophotometer.

(2) RT-PCR

1 ug of the above RNA is taken by using Invitrogen reverse transcription kit, 1 ul of random primer and 1 ul of dNTP are added, 10 ul is complemented by DEPC-H20, the RNA is put at 65° C. for 5 minutes and then placed in ice bath immediately. The addition of 10 ul of cDNA synthetic mixed liquid is followed by placement for 10 minutes at 25° C., placement for 50 minutes at 50° C., placement for 5 minutes at 85° C. and placement in ice bath immediately, the addition of 1 ul of RNaseH is followed by placement in 37° C. water bath for 20 minutes, and the cDNA is preserved at −20° C.

The amplification of PTP α gene by Polymerase Chain Reaction (PCR) of sample DNA comprises two parts: the first part of PTP α 1 forward primer sequence: 5′-AGCATGGATTCCTGGTTCATTCTTGTTCTG-3′, reverse primer sequence: 5′-CTCTACAGACACCCGAATATTCCCATAG-3′, the second part of PTP α 2 forward primer sequence: 5′-AGTACTGGCCAGACCAAGGCTGCGGAC-3′, and reverse primer sequence: 5′-CGCTTACTTGAAGTTGGCATAATCTGA-3′. The amplification system is as follows: 5 ul of 10*buffer solution, 2ul of dNTP, 0.5 ul of 10 um01/L forward primer, 0.5 ul of 10 um01/L reverse primer, 3ul of cDNA, and double distilled water complementary to volume 48ul. After 95° C. deactivation is performed for 5 minutes, 1 U (diluted to 1 U/2ul prior to application) Platinum Tag DNA Polymerase High Fidelity (Invitrogen) is added. The amplification conditions include 40 seconds at 90° C., 40 seconds at 55° C., 120 seconds at 68° C. and 30 cycles in total.

B. Purification of PCR Products for Sequencing

(1) Conjugation and Conversion of PCR Product

The above PCR (Polymerase Chain Reaction) product is subjected to electrophoretic separation with 1% of agarose gel, and then the right PCR product is conjugated to a PCR2.1-TOPO carrier with the length of 3.9 kb and converted into escherichia coli cells (TOPO TA Cloning Kits, the product manufactured by Invitrogen). The specific steps are as follows: 1 ul of saline solution and 1 ul of TOPO carrier are added to 4ul of the PCR product, they are lightly and homogeneously mixed, and then, the mixture is on standing for 5 minutes at room temperature and placed for 10 minutes at 30° C. to wait for conjugation. Afterwards, 2ul of the mixture is taken out and added to E. coli (escherichia coli) solution, they are lightly and homogeneously mixed, the mixture is placed on ice for 10 minutes to wait for conversion and then placed in water bath at 42° C. for 30 seconds in order to implement reversed heat shock, and after that, the mixture is placed in ice bath immediately. 250ul of S.O.C. culture solution is added at room temperature, and after the lid is fastened, 1-hour shaking on a constant temperature shaking table at 37° C. is performed for recovery.

(2) Screening, Identification and Determination

100ul of converted bacterial liquid is dropwise added to 1.5% LB agar plate containing 100 ug/ml of ampecilin, then 40ul of X-gal is added, uniform coating is completed by a glass rod immediately, then the plate is placed in a constant temperature incubator at 37° C. for incubation for 18 hours, white colony is picked out and transferred to a 3 ml LB liquid culture medium, shaking culture is implemented over night by the constant temperature shaking table at 37° C., and a plasmid miniprep kit of Geneaid is used for extracting bacterial plasmid. The bacterial liquid is centrifuged for 2 minutes at the speed of 6000 rpm at first and supernatant is then removed, precipitates are added with 200ul of RNaseA-containing solution I, bacteria is re-suspended, 200ul of solution II is added and the solution is reversed lightly, mixed homogeneously and placed for 5 minutes for the purpose of cell lysis, then 300ul of solution III is added, the solution is reversed lightly, mixed homogeneously and centrifuged for 5 minutes, supernatant is transferred to a centrifugal column for centrifugation for 30 seconds at the speed of 10000 rpm, washing buffer solution containing ethanol is then added, centrifugation is implemented for 30 seconds at the speed of 10000 rpm, the buffer solution is completely removed, 50ul of 110 mmol/L Tris-HCL buffer solution (pH 8.5) is added to dissolve DNA, followed by standing for 2 minutes and then centrifugation for 2 minutes, and effluent liquid, which is bacterial plasmid DNA, is collected. 5 ul of DNA is added with 2ul of 10× buffer solution and 10 U restriction endonuclease EcoR I, 20ul volume is complemented by double distilled water, enzyme digestion is implemented for 2 hours in water bath at 37° C., electrophoretic separation is implemented with 1% of agarose gel, external segments are indeed present on plasmid in accordance with the identification, and DNA sequencing is implemented.

The present invention has the advantages that: a mutant PTP α gene group in malignant tumors, disclosed by the present invention, has not been reported domestically and overseas so far, and the application of the method for detecting mutant PTP α genes can bring direct guidance significance to the accurate diagnosis of malignant tumors in the aspect of molecular pathologic level, the development of new antitumor drugs and the targeted therapy.

### BRIEF DESCRIPTION OF THE DRAWINGS

FIG. 1: 20 exons of wild type PTP α gene, E represents exon.

FIG. 2: exons of ^{Δ}PTP α 245, 95 new nucleotide segments are inserted behind the 7111^{th} nucleotide, and partial deletion of the 6^{th} to the 20^{th} encoding exons is initiated.

FIG. 3: exons of ^{Δ}PTP α 652, deletion of the 10^{th}, 11^{th} and 12^{th} exons.

FIG. 4: exons of ^{Δ}PTP α 445, deletion of the 10^{th}, 11^{th} and 12^{th} exons, accompanied by the insertion of 340 nucleotides behind the 1681^{th} encoding exon.

FIG. 5: the RT-PCR results of different types of tumor samples, M represents 0.5 kb DNA Ladder; 1. normal mammary tissue; 2, mammary cancer 62; 3, normal liver tissue; 4, liver cancer; 5, normal colonic tissue; 6. intestinal cancer; ^{Δ}PTP α 245 is mutant gene; PTP α is wild type gene.

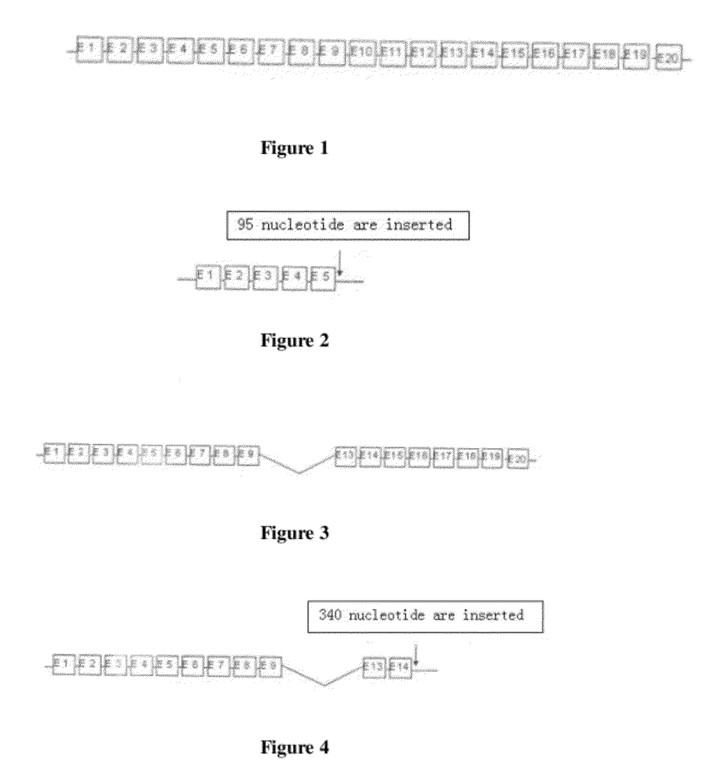

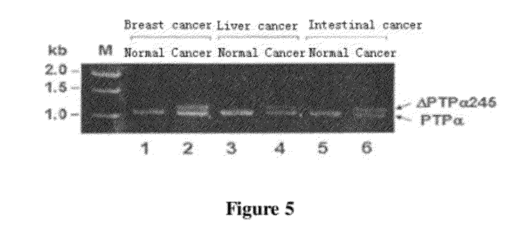

### DETAILED DESCRIPTION OF THE EMBODIMENTS

Detailed description is made below to the embodiments of technical proposal provided by the invention with reference to the drawings.

### Embodiment

I. Cloning of PTP α Mutant Gene

(1) Extraction of Total RNA

A patient's tumor tissue resulting from surgical excision is cut into pieces and RNA is extracted by 1 ml of TRIzol reagent (Invitrogen), the addition of 0.2 ml of chloroform is followed by violent shaking for 15 seconds, placement for 10 minutes at room temperature and centrifugation for 15 minutes at the speed of 15000 rpm at 4, supernatant is sucked and added with 0.5 ml of isopropanol for homogeneous mixing, the mixture is put on a standing for 10 minutes and then centrifuged for 10 minutes at the speed of 15000 rpm, the supernatant is removed, precipitates are washed with 75% ethanol and then dissolved in 20ul of DEPC-H20. After 2ul of the resultant solution is diluted, absorbance is determined by ultraviolet spectrophotometer.

(2) RT-PCR

1ug of the above RNA is taken by using Invitrogen reverse transcription kit, 1 ul of random primer and 1 ul of dNTP are added, 10ul is complemented by DEPC-H20, the RNA is put at 65° C. for 5 minutes and then placed in ice bath immediately. The addition of 10 ul of cDNA synthetic mixed liquid is followed by placement for 10 minutes at 25° C., placement for 50 minutes at 50° C., placement for 5 minutes at 85° C. and placement in ice bath immediately, the addition of 1 ul of RNaseH is followed by placement in 37° C. water bath for 20 minutes, and the cDNA is preserved at −20° C.

The amplification of PTP α gene by Polymerase Chain Reaction (PCR) of sample DNA comprises two parts: the first part of PTP α 1 forward primer sequence: 5′-AGCATGGATTCCTGGTTCATTCTTGTTCTG-3′, reverse primer sequence: 5′-CTCTACAGACACCCGAATATTCCCATAG-3′, the second part of PTP α 2 forward primer sequence: 5′-AGTACTGGCCAGACCAAGGCTGCGGAC-3′, and reverse primer sequence: 5′-CGCTTACTTGAAGTTGGCATAATCTGA-3′. The amplification system is as follows: 5 ul of 10*buffer solution, 2ul of dNTP, 0.5 ul of 10 um01/L forward primer, 0.5 ul of 10 um01/L reverse primer, 3ul of cDNA, and double distilled water complementary to volume 48ul. After 95° C. deactivation is performed for 5 minutes, 1 U (diluted to 1 U/2ul prior to application) Platinum Tag DNA Polymerase High Fidelity (Invitrogen) is added. The amplification conditions include 40 seconds at 90° C., 40 seconds at 55° C., 120 seconds at 68° C. and 30 cycles in total.

II. Purification of PCR Products for Sequencing

(1) Conjugation and Conversion of PCR Product

The above PCR (Polymerase Chain Reaction) product is subjected to electrophoretic separation with 1% of agarose gel, and then the right PCR product is conjugated to a PCR2.1-TOPO carrier with the length of 3.9 kb and converted into escherichia coli cells (TOPO TA Cloning Kits, the product manufactured by Invitrogen). The specific steps are as follows: 1 ul of saline solution and 1 ul of TOPO carrier are added to 4ul of the PCR product, they are lightly and homogeneously mixed, and then, the mixture is on standing for 5 minutes at room temperature and placed for 10 minutes at 30° C. to wait for conjugation. Afterwards, 2ul of the mixture is taken out and added to E. coli (escherichia coli) solution, they are lightly and homogeneously mixed, the mixture is placed on ice for 10 minutes to wait for conversion and then placed in water bath at 42° C. for 30 seconds in order to implement reversed heat shock, and after that, the mixture is placed in ice bath immediately. 250ul of S.O.C. culture solution is added at room temperature, and after the lid is fastened, 1-hour shaking on a constant temperature shaking table at 37° C. is performed for recovery.

(2) Screening, Identification and Determination

100ul of well-converted bacterial liquid is dropwise added to 1.5% LB agar plate containing 100 ug/ml of penbritin, then 40ul of X-gal is added, uniform coating is completed by a glass rod immediately, then the plate is placed in a constant temperature incubator at 37° C. for incubation for 18 hours, white colony is picked out and transferred to a 3 ml LB liquid culture medium, shaking culture is implemented over night by the constant temperature shaking table at 37° C., and a plasmid miniprep kit of Geneaid is used for extracting bacterial plasmid. The bacterial liquid is centrifuged for 2 minutes at the speed of 6000 rpm at first and supernatant is then removed, precipitates are added with 200ul of RNaseA-containing solution I, bacteria is re-suspended, 200ul of solution II is added and the solution is reversed lightly, mixed homogeneously and placed for 5 minutes for the purpose of cell lysis, then 300ul of solution III is added, the solution is reversed lightly, mixed homogeneously and centrifuged for 5 minutes, supernatant is transferred to a centrifugal column for centrifugation for 30 seconds at the speed of 10000 rpm, washing buffer solution containing ethanol is then added, centrifugation is implemented for 30 seconds at the speed of 10000 rpm, the buffer solution is completely removed, 50ul of 110 mmol/L Tris-HCL buffer solution (pH 8.5) is added to dissolve DNA, followed by standing for 2 minutes and then centrifugation for 2 minutes, and effluent liquid, which is bacterial plasmid DNA, is collected. 5 ul of DNA is added with 2ul of 10× buffer solution and 10 U restriction endonuclease EcoR I, 20ul volume is complemented by double distilled water, enzyme digestion is implemented for 2 hours in water bath at 37° C., electrophoretic separation is implemented with 1% of agarose gel, external segments are indeed present on plasmid in accordance with the identification, and DNA sequencing is implemented.

What is described above pertains merely to the preferred embodiments of the present invention, it shall be noted that several improvements and modifications can be made by ordinary skilled in this art without departing from the principle and premise of the present invention, and these improvements and modifications shall also be considered to be within the scope of protection of the present invention.

1.-5. (canceled)

6. A method for treating wastewater containing heavy metals, comprising:
directing the wastewater across a reverse osmosis aromatic polyamide membrane at a pressure ranging from 40-120 psi, said membrane having a pore size of less than 2 nm for rejecting particles and being capable of removing at least 90% of the heavy metals from the wastewater.

7. The method as claimed in claim 6, wherein said membrane has a water flux ranging from 0.005 m³/m²·h to 0.025 m³/m²·h.

8. The method as claimed in claim 6, wherein said membrane has a rejection percentage of at least 99% arsenic.

9. The method as claimed in claim 6, wherein said membrane has a rejection percentage from the wastewater of at least 98% nickel, at least 97% manganese, 99.9% magnesium, 94% chromium, and at least 80% rejection of cadmium, copper and zinc.
